(19) United States
(12) Patent Application Publication
(10) Pub. No.: US 2016/0073125 A1
(43) Pub. Date: Mar. 10, 2016

(54) VIDEO ENCODING APPARATUS AND METHOD, VIDEO DECODING APPARATUS AND METHOD, AND PROGRAMS THEREFOR

(71) Applicant: NIPPON TELEGRAPH AND TELEPHONE CORPORATION, Tokyo (JP)

(72) Inventors: Shiori SUGIMOTO, Yokosuka-shi (JP); Shinya SHIMIZU, Yokosuka-shi (JP); Hideaki KIMATA, Yokosuka-shi (JP); Akira KOJIMA, Yokosuka-shi (JP)

(73) Assignee: NIPPON TELEGRAPH AND TELEPHONE CORPORATION, Tokyo (JP)

(21) Appl. No.: 14/783,355

(22) PCT Filed: Apr. 11, 2014
(86) PCT No.: PCT/JP2014/060489

§ 371 Date: Oct. 8, 2015

(30) Foreign Application Priority Data
Apr. 12, 2013 (JP) 2013-084197

(51) Int. Cl. H04N 19/503; H04N 19/65; H04N 19/17

(52) U.S. Cl. CPC H04N 19/503; H04N 19/17; H04N 19/65

(57) ABSTRACT

An apparatus performs inter-frame prediction in directions pertaining to time and disparity and predictive-encodes an encoding target video by generating a predicted image whose error is corrected. An encoding target image is predicted by utilizing reference pictures which are previously-decoded pictures in the directions pertaining to time and disparity; and inter-frame reference information and inter-viewpoint reference information which indicate individual reference parts on the reference pictures are determined. A disparity predicted image and a motion predicted image are generated based on the determined information items. A corrective predicted image is generated based on the inter-viewpoint reference information and the inter-frame reference information. The predicted image is generated from the disparity predicted image, the motion predicted image, and the corrective predicted image.

### TECHNICAL FIELD

The present invention relates to a video encoding apparatus, a video decoding apparatus, a video encoding method, a video decoding method, a video encoding program, and a video decoding program, and in particular, relates to inter-frame predictive encoding and decoding in directions pertaining to time and disparity.

### BACKGROUND ART

In general video encoding, spatial and temporal continuity of each object is utilized to divide each video frame into blocks as units to be processed. A video signal of each block is spatially or temporally predicted, and prediction information, that indicates utilized prediction method, and a prediction residual are encoded, which considerably improves the encoding efficiency in comparison with a case of encoding the video signal itself.

In addition, conventional two-dimensional video encoding performs intra prediction that predicts an encoding target signal with reference to previously-encoded blocks in the current frame; and inter prediction that predicts the encoding target signal based on motion compensation or the like with reference to a previously-encoded frame.

Below, multi-view video encoding will be explained. The multi-view video encoding encodes a plurality of videos, which were obtained by photographing the same scene by a plurality of cameras, with high encoding efficiency by utilizing the redundancy between the videos. Non-Patent Document 1 explains the multi-view video encoding in detail.

In addition to the prediction method used in general video encoding, the multi-view video encoding utilizes (i) inter-view (or inter-viewpoint) prediction that predicts an encoding target signal based on disparity compensation with reference to a previously-encoded video from another viewpoint, (ii) inter-view residual prediction that predicts an encoding target signal by means of inter-frame prediction and predicts a residual signal for the above prediction with reference to a residual signal at the time of encoding of a previously-encoded video from another viewpoint. In the multi-view video encoding, the inter-view prediction is treated as inter prediction together with inter-frame prediction, where for B-pictures, interpolation utilizing two or more predicted images may be performed to produce a predicted image.

As described above, in the multi-view video encoding, the prediction utilizing both the inter-frame prediction and the inter-view prediction is applied to pictures to which the both predictions can be applied.

### PRIOR ART DOCUMENT

### Non-Patent Document

Non-Patent Document 1: M. Flierl and B. Girod, “Multiview video compression,” Signal Processing Magazine, IEEE, no. November 2007, pp. 66-76, 2007.

### DISCLOSURE OF INVENTION

### Problem to be Solved by the Invention

However, the nature of the error differs between the motion compensated prediction and the disparity compensated prediction. Therefore, in comparison with a case which employs only the inter-frame prediction, it is difficult to obtain the error cancelling effect, depending on the nature of the relevant sequence (of an image signal).

The above-described errors may be caused by (i) deformation or the like of an object or blurring in the motion compensated prediction, or (ii) difference in the qualities of the cameras or the occurrence of occlusion in the disparity-compensated prediction. In such a case, the prediction method having a higher accuracy is almost selected and thus no prediction utilizing “both prediction methods” is hardly utilized.

Therefore, in an example, a B-picture, to which forward prediction and the inter-view prediction can be applied, is actually subjected to only unidirectional prediction even when the prediction utilizing “both prediction methods” can be performed in consideration of the structure of the picture. Accordingly, sufficient effect for the reduction of the prediction residual cannot be obtained.

In light of the above circumstances, an object of the present invention is to provide a video encoding apparatus, a video decoding apparatus, a video encoding method, a video decoding method, a video encoding program, and a video decoding program, by which the prediction residual can be reduced and the amount of code required for encoding the prediction residual can be reduced.

### Means for Solving the Problem

The present invention provides a video encoding apparatus that performs inter-frame prediction in directions pertaining to time and disparity and predictive-encodes an encoding target video by generating a predicted image whose error is corrected, the apparatus comprising:

a prediction device that:
predicts an encoding target image by utilizing reference pictures which are previously-decoded pictures in the directions pertaining to time and disparity; and
determines inter-frame reference information and inter-viewpoint reference information which indicate individual reference parts on the reference pictures;

a primary predicted image generation device that generates a disparity predicted image based on the inter-viewpoint reference information and a motion predicted image based on the inter-frame reference information;

a corrective predicted image generation device that generates a corrective predicted image based on the inter-viewpoint reference information and the inter-frame reference information; and

a predicted image generation device that generates the predicted image from the disparity predicted image, the motion predicted image, and the corrective predicted image.

In a typical example, the predicted image generation device generates the predicted image by adding the disparity predicted image to the motion predicted image and subtracting the corrective predicted image from the sum of the addition.

In a preferable example, the inter-viewpoint reference information and the inter-frame reference information each include information utilized to identify the corresponding reference picture; and

the corrective predicted image generation device generates the corrective predicted image with reference to a reference picture, as a corrective reference picture, which is a picture from the same viewpoint as that of the reference picture indicated by the inter-viewpoint reference information and belongs to a frame (time) to which the reference picture indicated by the inter-frame reference information belongs.

In this case, it is possible that:

the inter-viewpoint reference information and the inter-frame reference information each further include information utilized to identify a reference position on the corresponding reference picture; and

the corrective predicted image generation device generates the corrective predicted image by determining a reference position on the corrective reference picture based on the inter-viewpoint reference information and the inter-frame reference information.

In another preferable example, the apparatus further comprises a prediction information encoding device that encodes information utilized to identify the inter-viewpoint reference information and the inter-frame reference information.

The prediction device may generate any one of the inter-frame reference information and the inter-viewpoint reference information based on prediction information utilized when the reference part indicated by the other reference information was encoded.

The present invention also provides a video decoding apparatus that decodes code data which has been predictive-encoded by performing inter-frame prediction in directions pertaining to time and disparity and generating a predicted image whose error is corrected, the apparatus comprising:

a prediction device that:
predicts a decoding target image by utilizing reference pictures which are previously-decoded pictures in the directions pertaining to time and disparity; and
determines inter-frame reference information and inter-viewpoint reference information which indicate individual reference parts on the reference pictures;

a primary predicted image generation device that generates a disparity predicted image based on the inter-viewpoint reference information and a motion predicted image based on the inter-frame reference information;

a corrective predicted image generation device that generates a corrective predicted image based on the inter-viewpoint reference information and the inter-frame reference information; and

a predicted image generation device that generates the predicted image from the disparity predicted image, the motion predicted image, and the corrective predicted image.

In a typical example, the predicted image generation device generates the predicted image by adding the disparity predicted image to the motion predicted image and subtracting the corrective predicted image from the sum of the addition.

In a preferable example, the inter-viewpoint reference information and the inter-frame reference information each include information utilized to identify the corresponding reference picture; and

the corrective predicted image generation device generates the corrective predicted image with reference to a reference picture, as a corrective reference picture, which is a picture from the same viewpoint as that of the reference picture indicated by the inter-viewpoint reference information and belongs to a frame (time) to which the reference picture indicated by the inter-frame reference information belongs.

In this case, it is possible that:

the inter-viewpoint reference information and the inter-frame reference information each further include information utilized to identify a reference position on the corresponding reference picture; and

the corrective predicted image generation device generates the corrective predicted image by determining a reference position on the corrective reference picture based on the inter-viewpoint reference information and the inter-frame reference information.

In another preferable example, the apparatus further comprises a prediction information decoding device that decodes prediction information from the code data so as to generate prediction information utilized to identify the inter-viewpoint reference information and the inter-frame reference information,

wherein the prediction device determines the inter-frame reference information and the inter-viewpoint reference information based on the generated prediction information.

The prediction device may decode any one of the inter-frame reference information and the inter-viewpoint reference information from the code data and generate the other reference information based on prediction information utilized when the reference part indicated by the decoded reference information was decoded.

The present invention also provides a video encoding method performed by a video encoding apparatus that performs inter-frame prediction in directions pertaining to time and disparity and predictive-encodes an encoding target video by generating a predicted image whose error is corrected, the method comprising:

a prediction step that:
predicts an encoding target image by utilizing reference pictures which are previously-decoded pictures in the directions pertaining to time and disparity; and
determines inter-frame reference information and inter-viewpoint reference information which indicate individual reference parts on the reference pictures;

a primary predicted image generation step that generates a disparity predicted image based on the inter-viewpoint reference information and a motion predicted image based on the inter-frame reference information;

a corrective predicted image generation step that generates a corrective predicted image based on the inter-viewpoint reference information and the inter-frame reference information; and

a predicted image generation step that generates the predicted image from the disparity predicted image, the motion predicted image, and the corrective predicted image.

The present invention also provides a video decoding method performed by a video decoding apparatus that decodes code data which has been predictive-encoded by performing inter-frame prediction in directions pertaining to time and disparity and generating a predicted image whose error is corrected, the method comprising:

a prediction step that:
predicts a decoding target image by utilizing reference pictures which are previously-decoded pictures in the directions pertaining to time and disparity; and
determines inter-frame reference information and inter-viewpoint reference information which indicate individual reference parts on the reference pictures;

a primary predicted image generation step that generates a disparity predicted image based on the inter-viewpoint reference information and a motion predicted image based on the inter-frame reference information;

a corrective predicted image generation step that generates a corrective predicted image based on the inter-viewpoint reference information and the inter-frame reference information; and

a predicted image generation step that generates the predicted image from the disparity predicted image, the motion predicted image, and the corrective predicted image.

The present invention also provides a video encoding program utilized to make a computer execute the above video encoding method.

The present invention also provides a video decoding program utilized to make a computer execute the above video decoding method.

### Effect of the Invention

According to the present invention, the prediction residual can be reduced and the amount of code required for encoding the prediction residual can be reduced, and thereby it is possible to improve the encoding efficiency.

### BRIEF DESCRIPTION OF THE DRAWINGS

FIG. 1 is a block diagram that shows the structure of a video encoding apparatus according to an embodiment of the present invention.

FIG. 2 is a flowchart showing the operation of the video encoding apparatus 100 shown in FIG. 1.

FIG. 3 is a block diagram that shows the structure of a video decoding apparatus according to an embodiment of the present invention.

FIG. 4 is a flowchart showing the operation of the video decoding apparatus 200 shown in FIG. 3.

FIG. 5 is a diagram showing the concept of the corrective prediction.

FIG. 6 is a diagram that shows a hardware configuration of the video encoding apparatus 100 shown in FIG. 1, which is formed using a computer and a software program.

FIG. 7 is a diagram that shows a hardware configuration of the video decoding apparatus 200 shown in FIG. 3, which is formed using a computer and a software program.

### MODE FOR CARRYING OUT THE INVENTION

Below, a video encoding apparatus and a video decoding apparatus as embodiments of the present invention will be explained with reference to the drawings.

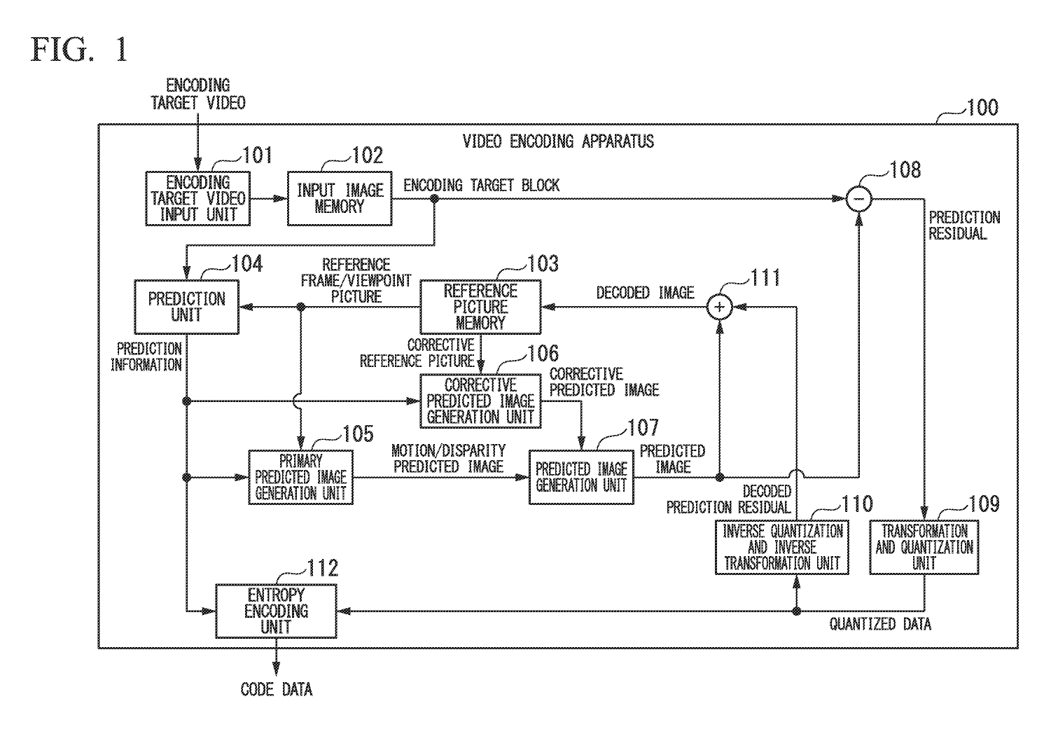

First, a video encoding apparatus will be explained. FIG. 1 is a block diagram that shows the structure of the video encoding apparatus according to the embodiment.

As shown in FIG. 1, the video encoding apparatus 100 has an encoding target video input unit 101, an input image memory 102, a reference picture memory 103, a prediction unit 104, a primary predicted image generation unit 105, a corrective predicted image generation unit 106, a predicted image generation unit 107, a subtraction unit 108, a transformation and quantization unit 109, an inverse quantization and inverse transformation unit 110, an addition unit 111, and an entropy encoding unit 112.

The encoding target video input unit 101 is utilized to input a video (image) as an encoding target into the video encoding apparatus 100. Below, this video as an encoding target is called an “encoding target video”. In particular, a frame to be processed is called an “encoding target frame” or an “encoding target image”.

The input image memory 102 stores the input encoding target video.

The reference picture memory 103 stores images that have been encoded and decoded. Below, each frame stored in the memory 103 is called an “encoding target video”. In particular, a frame to be processed is called a “reference frame” or a “reference picture”.

The prediction unit 104 generates prediction information by subjecting the encoding target image to prediction in both directions pertaining to time and disparity, by utilizing a reference picture stored in the reference picture memory 103.

Based on the prediction information, the primary predicted image generation unit 105 generates a motion predicted image and a disparity predicted image.

Again based on the prediction information, the corrective predicted image generation unit 106 generates a corrective predicted image by determining a corrective reference picture and a corrective reference region within the corrective reference picture.

The predicted image generation unit 107 generates a predicted image by utilizing the motion predicted image, the disparity predicted image, and the corrective predicted image.

The subtraction unit 108 computes a difference between the encoding target image and the predicted image so as to generate a prediction residual.

The transformation and quantization unit 109 subjects the generated prediction residual to transformation and quantization to generate quantized data.

The inverse quantization and inverse transformation unit 110 subjects the generated quantized data to inverse quantization and inverse transformation so as to generate a decoded prediction residual.

The addition unit 111 generates a decoded image by adding the decoded prediction residual to the prediction residual.

The entropy encoding unit 112 subjects the quantized data to entropy encoding so as to generate code (or encoded) data.

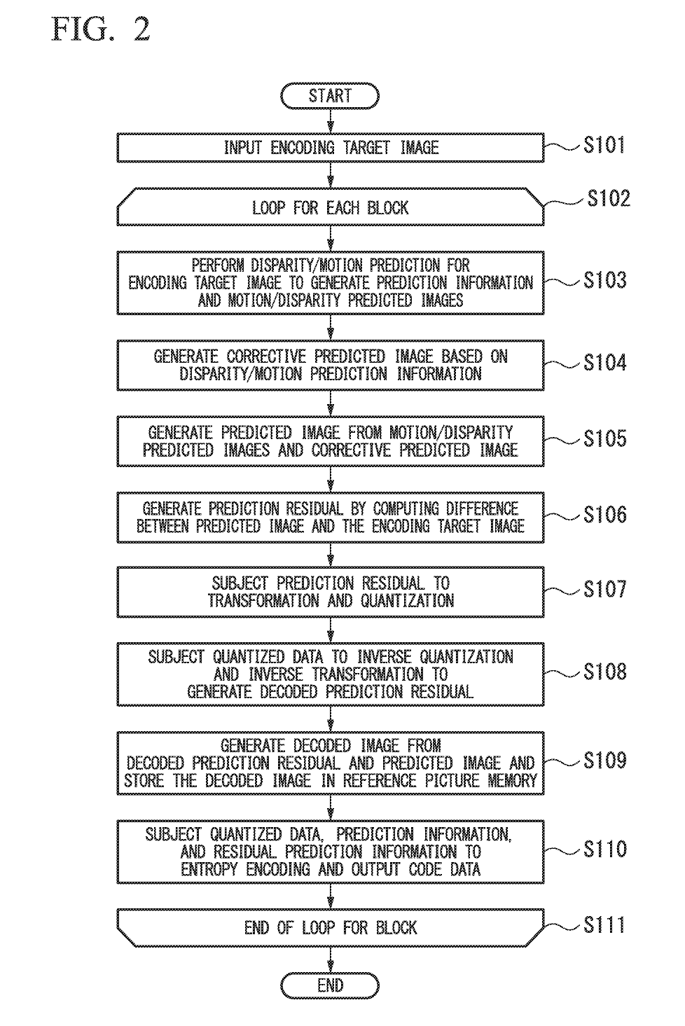

Next, the operation of the video encoding apparatus 100 shown in FIG. 1 will be explained with reference to FIG. 2. FIG. 2 is a flowchart showing the operation of the video encoding apparatus 100 shown in FIG. 1.

Here, it is assumed that the encoding target video is one-view video of a multi-view video, and videos of all views (viewpoints) in the multi-view video are encoded and decoded one by one. Additionally, in the operation explained here, a frame of the encoding target video is encoded. The entire video can be encoded by repeating the explained operation for each frame.

First, the encoding target frame is input via the encoding target video input unit 101 into the video encoding apparatus 100. The encoding target video input unit 101 stores the frame in the input image memory 102 (see step S101).

Here, some frames in the encoding target video have been previously encoded, and decoded frames thereof are stored in the reference picture memory 103.

In addition, for the other videos from viewpoints other than that of the encoding target video, some frames (up to the frame that corresponds to the encoding target frame) which can be referred to have also been previously encoded and decoded, and the relevant frames are stored in the input image memory 102.

After the video input, the encoding target frame is divided into encoding target blocks and each block is subjected to encoding of a video signal of the encoding target frame (see steps S102 to S111).

The following steps S103 to S110 are repeatedly executed for all blocks in the frame.

In the operation repeated for each block, first, the prediction unit 104 generates prediction information by subjecting the encoding target block to (i) motion prediction that refers to a reference picture which belongs to a frame (time) other than that of the encoding target block and (ii) disparity prediction that refers to a reference picture from a viewpoint other than that of the encoding target block. Based on the generated prediction information, the primary predicted image generation unit 105 generates a motion predicted image and a disparity predicted image (see step S103).

The above prediction and prediction information generation may be performed by any method, and the prediction information may have any property.

Typically, the prediction information is inter-view (or inter-viewpoint) reference information (for the disparity prediction) or inter-frame reference information (for the motion prediction), which consists of an index utilized to identify the reference picture and a vector that indicates a reference part on the reference picture.

The individual reference information may be determined by any method. For example, the reference picture is searched for a region that corresponds to the encoding target block. In another example, the reference information may be determined by utilizing prediction information for a peripheral block (around encoding target block) which has been encoded and decoded.

The disparity prediction and the motion prediction may be carried out independently, may be executed one after another, or may be repeated alternately. Alternatively, a combination of reference pictures may be determined in advance and both predictions may be performed independently or one after another, based on the combination.

For example, it may be predetermined that the reference picture for the disparity prediction is always a picture from the 0th viewpoint and that the reference picture for the motion prediction is always a picture that belongs to the head frame.

In addition, information utilized to identify the combination may be encoded and multiplexed with video code data. If an identical combination can be specified in the corresponding decoding apparatus, such encoding may be omitted.

When the disparity prediction and the motion prediction are executed simultaneously, they may be performed for all relevant combinations so as to evaluate the combinations. Alternatively, such combinations may be coordinated to perform optimization. In another example, a process in which one prediction is provisionally decided while a search is performed for the other prediction may be repeatedly executed.

For prediction accuracy evaluation, the prediction accuracies of the individual predicted images may be evaluated separately, or the accuracy of an image obtained by mixing both predicted images may be evaluated. Alternatively, the accuracy of a final predicted image obtained after corrective prediction explained later is executed may be evaluated. It is also possible to perform the prediction by using any other method.

Furthermore, the prediction information may be encoded and multiplexed with video code data. As described above, if the prediction information can be obtained based on the prediction information for peripheral blocks, own residual prediction information, or the like, no encoding may be performed. Alternatively, the prediction information may be predicted and a residual thereof may be encoded.

When the prediction information includes the inter-view reference information and the inter-frame reference information, these information items may be encoded if necessary or may not be encoded if they can be determined according to a predetermined rule. In an example, either one of both information items is encoded, and the other one is produced based on prediction information generated when a reference region indicated by the encoded information was encoded.

Next, based on the prediction information, the corrective predicted image generation unit 106 generates a corrective predicted image by determining a corrective reference picture and a corrective reference region within the corrective reference picture (see step S104).

After generating the corrective predicted image, the predicted image generation unit 107 generates a predicted image by utilizing the motion predicted image, the disparity predicted image, and the corrective predicted image (see step S105).

The corrective prediction corrects individual prediction errors for the motion prediction (for a reference picture that belongs to a frame (time) other than the encoding target frame) and the disparity prediction (for a reference picture from a viewpoint other than that of the encoding target frame), by utilizing a reference picture other than these reference pictures.

Here, a picture referred to in the motion prediction is called a “reference frame picture”, a picture referred to in the disparity prediction is called a “reference viewpoint picture”, and a picture referred to in the corrective prediction is called a “corrective reference picture”. The corrective prediction will be explained later in detail.

Next, the subtraction unit 108 generates a prediction residual by computing a difference between the predicted image and the encoding target block (see step S106).

Here, the prediction residual is generated after producing a final predicted image. However, the prediction residual may be generated through the following steps:

(i) computing predicted values (which may be called “predicted prediction residuals”) for individual prediction residuals between the corrective predicted image and the motion predicted image and between the corrective predicted image and the disparity predicted image;
(ii) generating motion and disparity prediction residuals by computing difference between the motion predicted image and the encoding target block and between the disparity predicted image and the encoding target block; and
(iii) generating the prediction residual by updating the motion and disparity prediction residuals individually based on the above-described predicted values for the individual prediction residuals.

When the generation of the prediction residual is completed, the transformation and quantization unit 109 subjects the prediction residual to transformation and quantization to generate quantized data (see step S107). The transformation and quantization may be performed by any method if the obtained data can be accurately inverse-quantized and inverse-transformed in a decoding process.

When the transformation and quantization is completed, the inverse quantization and inverse transformation unit 110 subjects the quantized data to inverse quantization and inverse transformation to generate a decoded prediction residual (see step S108).

Next, when the generation of the decoded prediction residual is completed, the addition unit 111 adds the decoded prediction residual to the predicted image so as to generate a decoded image which is stored in the reference picture memory 103 (see step S109).

In this process, as described above, a predicted value of the relevant prediction residual may be computed, and a primary prediction residual, which is a difference between the primary predicted image and the encoding target block, may be generated by updating the primary prediction residual based on the above predicted value.

In addition, the decoded image may be multiplied by a loop filter, if necessary. In general video encoding, encoding noises are removed utilizing a deblocking filter or another filter.

Next, the entropy encoding unit 112 subjects the quantized data to entropy encoding so as to generate code data. If necessary, prediction information, residual prediction information, or other additional information may also be encoded and multiplexed with the code data. After all blocks are processed, the code data is output (see step S110).

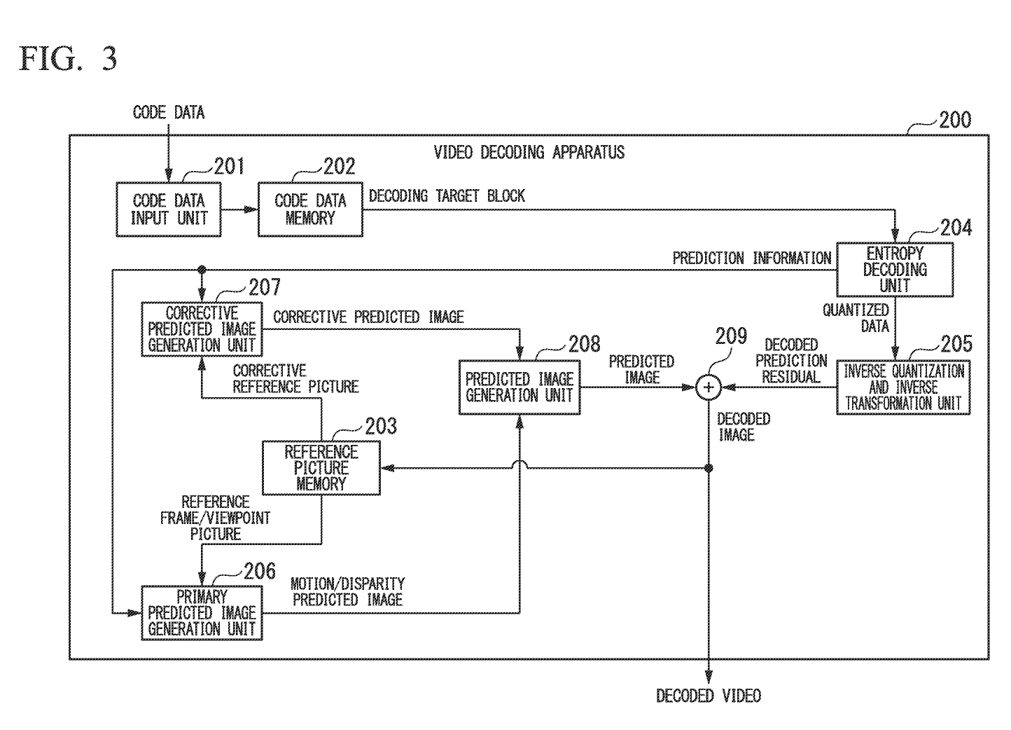

Below, the video decoding apparatus will be explained. FIG. 3 is a block diagram that shows the structure of a video decoding apparatus according to an embodiment of the present invention.

As shown in FIG. 3, the video decoding apparatus 200 includes a code data input unit 201, a code data memory 202, a reference picture memory 203, an entropy decoding unit 204, an inverse quantization and inverse transformation unit 205, a primary predicted image generation unit 206, a corrective predicted image generation unit 207, a predicted image generation unit 208, and an addition unit 209.

Video code data as a decoding target is input into the video decoding apparatus 200 via the code data input unit 201. Below, this video code data as a decoding target is called a “decoding target video code data”. In particular, a frame to be processed is called a “decoding target frame” or a “decoding target image”.

The code data memory 202 stores the input decoding target video.

The reference picture memory 203 stores images which have been previously decoded.

The entropy decoding unit 204 subjects the code data of the decoding target frame to entropy decoding, and the inverse quantization and inverse transformation unit 205 subjects the relevant quantized data to inverse quantization and inverse transformation so as to generate a decoded prediction residual.

The primary predicted image generation unit 206 generates a motion predicted image and a disparity predicted image.

The corrective predicted image generation unit 207 generates a corrective predicted image by determining a corrective reference picture and a corrective reference region within the corrective reference picture.

The predicted image generation unit 208 generates a predicted image by utilizing the motion predicted image, the disparity predicted image, and the corrective predicted image.

The addition unit 209 generates a decoded image by adding the decoded prediction residual to the prediction residual.

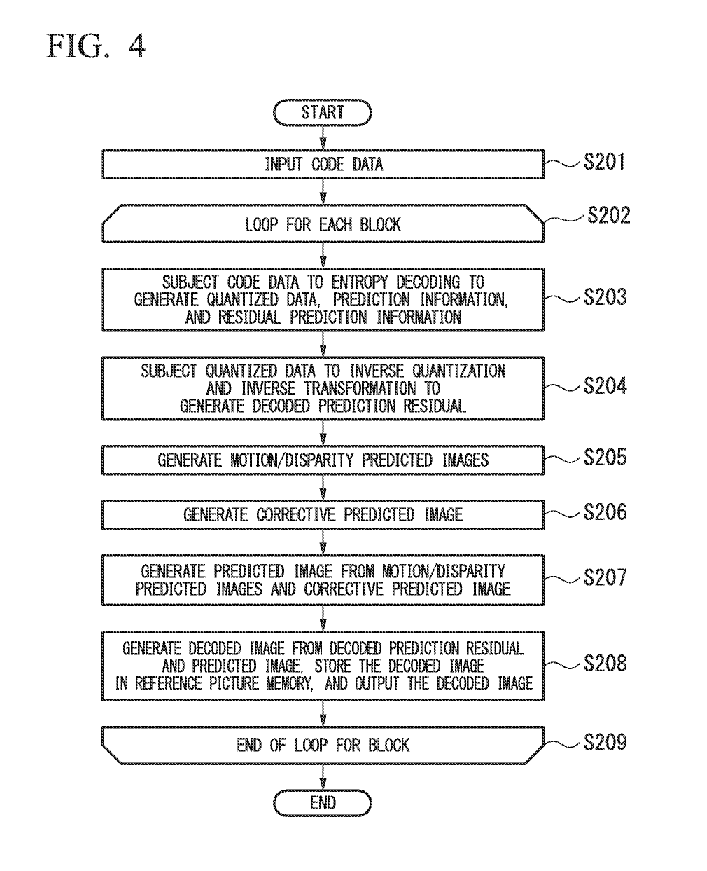

Next, the operation of the video decoding apparatus 200 shown in FIG. 3 will be explained with reference to FIG. 4. FIG. 4 is a flowchart showing the operation of the video decoding apparatus 200 shown in FIG. 3.

Here, it is assumed that the decoding target video is one-view video of a multi-view video, and videos of all views (viewpoints) in the multi-view video are decoded one by one. Additionally, in the operation explained here, a frame of the code data is decoded. The entire video can be decoded by repeating the explained operation for each frame.

First, video code data is input into the video decoding apparatus 200 via the code data input unit 201 which stores the data in the code data memory 202 (see step S201).

Here, some frames in the decoding target video have been previously decoded, and the relevant decoded frames are stored in the reference frame memory 203. In addition, the additional video memory 207 also stores additional frames that correspond to the decoded frames stored in the reference frame memory 203.

In addition, for the other videos from viewpoints other than that of the decoding target video, some frames (up to the frame that corresponds to the encoding target frame) which can be referred to have also been previously decoded, and the relevant decoded frames are stored in the reference picture memory 203.

After the code data input, the decoding target frame is divided into decoding target blocks and each block is subjected to decoding of a video signal of the decoding target frame (see steps S202 to S209).

The following steps S203 to S208 are repeatedly executed for all blocks in the frame.

In the operation repeated for each decoding target block, first, the entropy decoding unit 204 subjects the code data to entropy decoding (see step S203).

The inverse quantization and inverse transformation unit 205 performs the inverse quantization and inverse transformation so as to generate a decoded prediction residual (see step S204). If prediction information or other additional information is included in the code data, such information may also be decoded so as to appropriately generate required information.

Next, the primary predicted image generation unit 206 generates a motion predicted image and a disparity predicted image (see step S205).

When the prediction information has been encoded and multiplexed with video code data, the relevant information may be (decoded and) utilized to generate the predicted image. As described above, if the prediction information can be obtained based on the prediction information for peripheral blocks, own residual prediction information, or the like, such encoded information may be omitted. In addition, if one of two prediction information items can be derived from the other prediction information, information in which only said one of two prediction information items has been encoded may be utilized.

Additionally, when a prediction residual of the prediction information has been encoded, the prediction residual may be decoded and utilized to predict the prediction information. A detailed operation thereof is similar to that performed in the corresponding encoding apparatus.

Next, based on the prediction information, the corrective predicted image generation unit 207 generates a corrective predicted image by determining a corrective reference picture and a corrective reference region within the corrective reference picture (see step S206).

After generating the corrective predicted image, the predicted image generation unit 208 generates a predicted image by utilizing the motion predicted image, the disparity predicted image, and the corrective predicted image (see step S207).

A detailed operation here is similar to that performed in the encoding apparatus. In the previous explanation, the prediction residual is generated after generating a final predicted image. However, the prediction residual may be generated by computing predicted values (i.e., predicted prediction residuals) for individual prediction residuals between the corrective predicted image and the motion predicted image and between the corrective predicted image and the disparity predicted image; and updating the decoded prediction residual based on the computed predicted values.

Next, when the generation of the predicted image is completed, the addition unit 209 adds the decoded prediction residual to the predicted image so as to generate a decoded image which is stored in the reference picture memory. After all blocks are processed, the decoded image is output (see step S208).

In addition, the decoded image may be multiplied by a loop filter, if necessary. In ordinary video encoding, encoding noises are removed utilizing a deblocking filter or another filter.

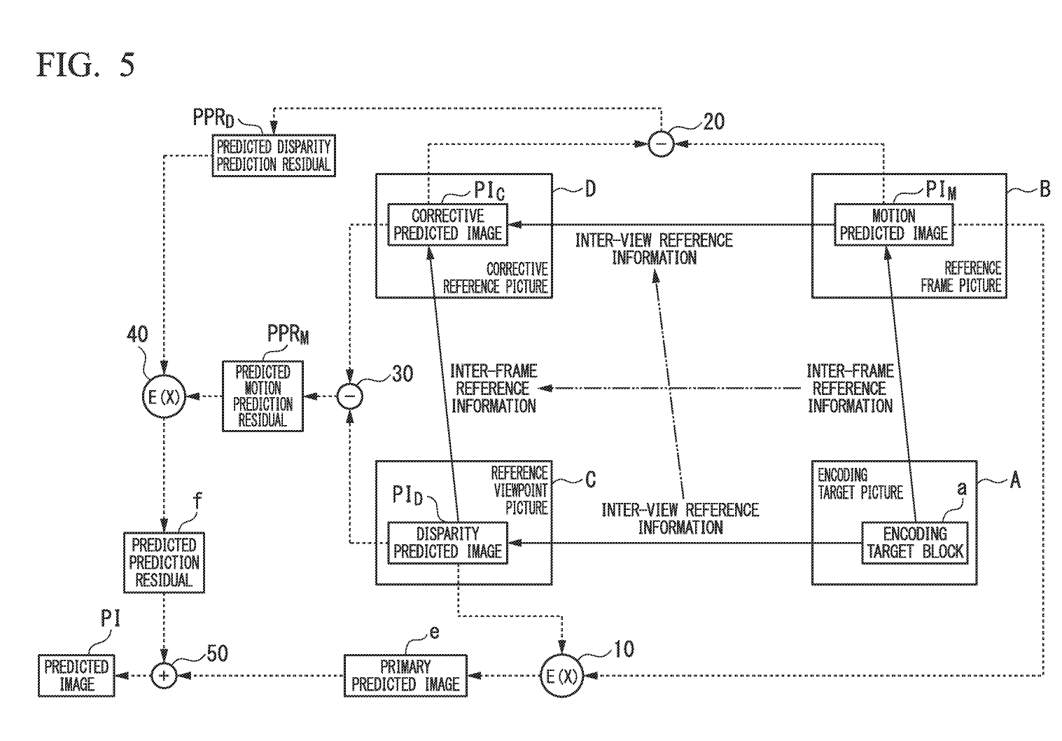

Next, with reference to FIG. 5, a detailed operation of the corrective prediction will be explained. FIG. 5 is a diagram showing the concept of the corrective prediction.

Here, a picture referred to in the motion prediction is called a “reference frame picture”, a picture referred to in the disparity prediction is called a “reference viewpoint picture”, and a picture referred to in the corrective prediction is called a “corrective reference picture”.

As the corrective reference picture, any type of picture may be selected. In an example shown in FIG. 5, the corrective reference picture belongs to a frame (time) to which the reference frame picture also belongs, and the corrective reference picture is a picture from the same viewpoint as that of the reference viewpoint picture.

First, a motion predicted image PI_{M} is generated by a prediction with respect to an encoding target block “a” in an encoding target picture A, and a picture including the generated image is stored as a reference frame picture B.

In addition, a disparity predicted image PI_{D} is generated by a prediction with respect to the encoding target block “a” in the encoding target picture A, and a picture including the generated image is stored as a reference viewpoint picture C.

Then a corrective predicted image PI_{C} is generated from the motion predicted image PI_{M} and the disparity predicted image PI_{D}, and a picture including the generated image is stored as a corrective reference picture D.

Next, an average of the motion predicted image PI_{M} and the disparity predicted image PI_{D} is computed by an averaging unit 10, and the averaged image is determined to be a primary predicted image “e”.

In addition, a difference between the motion predicted image PI_{M} and the corrective predicted image PI_{C} is computed by a subtracter 20, and the corresponding image is determined to be a predicted disparity prediction residual PPR_{D}.

Moreover, a difference between the disparity predicted image PI_{D} and the corrective predicted image PI_{C} is computed by a subtracter 30, and the corresponding image is determined to be a predicted motion prediction residual PPR_{M}.

Then, an average of the predicted disparity prediction residual PPR_{D} and the predicted motion prediction residual PPR_{M} is computed by an averaging unit 40, and the average is determined to be a predicted prediction residual “f”.

Finally, the primary predicted image “e” and the predicted prediction residual “f” are added by an adder 50 to generate a predicted image PI.

If the prediction information consists of the inter-view (or inter-viewpoint) reference information and the inter-frame reference information, a region to be referred to (as the corrective predicted image) on the corrective reference picture is determined by utilizing the individual reference information items.

For example, if the reference information items include vectors that indicates regions on the reference frame/viewpoint pictures, then a corrective vector V_{C} that indicates a region to be referred to (as the corrective predicted image) on the corrective reference picture is represented by the following formula that utilizing a motion vector V_{M} and a disparity vector V_{D}:

V_{C}=V_{M}+V_{D}

In the predicted image generation, the prediction error for the disparity predicted image PI_{D} with respect to the encoding target block is predicted by utilizing the corrective predicted image PI_{C} and the motion predicted image PI_{M}; and the prediction error for the motion predicted image PI_{M} with respect to the encoding target block is predicted by utilizing the corrective predicted image PI_{C} and the disparity predicted image PI_{D}. The final predicted image is generated in consideration of the errors for the motion predicted image and the disparity predicted image.

Below, the predicted prediction error for the motion prediction is called a “predicted motion prediction residual” (i.e., PPR_{M} as described above), and the predicted prediction error for the disparity prediction is called a “predicted disparity prediction residual” (i.e., PPR_{D} as described above).

Although any prediction method can be employed, in FIG. 5, differences between the corrective predicted image and the individual predicted images are determined to be the predicted (motion/disparity) prediction residuals. In this case, the predicted motion prediction residual PPR_{M} and the predicted disparity prediction residual PPR_{D} are represented by the following formulas:

PPR_{M}=PI_{D}−PI_{C} PPR_{D}=PI_{M}−PI_{C}

In addition, the primary prediction residuals are difference between the encoding target block and the motion predicted image and difference between the encoding target block and the disparity predicted image. Conceptually, if the corresponding predicted prediction residual is subtracted from the relevant primary prediction residual and the obtained difference is determined to be a prediction residual to be encoded, the amount of code for the prediction residual can be reduced. When the above determined prediction residuals (errors) are utilized to correct the predicted images for both predictions, the final predicted image PI is represented by the following formula:

$$\begin{matrix}PI = \frac{\{ ( {PI}_{M} + {PPR}_{M} ) + ( {PI}_{D} + {PPR}_{D} ) \}}{2} \\ = \frac{\{ ( {PI}_{M} + {PI}_{D} - {PI}_{C} ) + ( {PI}_{D} + {PI}_{M} - {PI}_{C} ) \}}{2} \\ = {PI}_{D} + {PI}_{M} - {PI}_{C}\end{matrix} \qquad [ Formula 1 ]$$

Accordingly, a formula as described above may be utilized to directly generate the final predicted image without generating the predicted prediction residuals.

Furthermore, in the above example, the predicted image before the correction is an average of the predicted images for motion and disparity. However, the predicted image may be generated by any weighting method to perform a correction that employs the weighting. In addition, a separate weight may be applied to the predicted prediction residual.

For example, when one of the above predictions has an accuracy lower than that of the other, a weight according to the lower accuracy may be applied to the corresponding prediction. Here, a weighting method employed when (in the above example) the accuracy of the disparity predicted image PI_{D} is lower than that of the motion predicted image PI_{M} will be explained. With given weight W applied to the disparity predicted image, the final predicted image PI can be represented by the following formula:

PI=PI_{M}+(PI_{D}−PI_{C})W [Formula 2]

The above weight W may be a matrix whose size is the image as that of the relevant image or may be a scalar. When W=1, the above formula coincides with Formula 1.

In addition, the weight W may be determined by any method. In a typical example, if the accuracy of the disparity compensated prediction is high, then W=1, and if this accuracy is not high, then W=½, and if the relevant accuracy is considerably low or there is no disparity vector to be utilized, then W=0.

Additionally, in part of the operations shown in FIGS. 2 and 4, the execution order of the steps may be modified.

The above-described video encoding and decoding operations may be implemented using a computer and a software program, where the program may be provided by storing it in a computer-readable storage medium, or through a network.

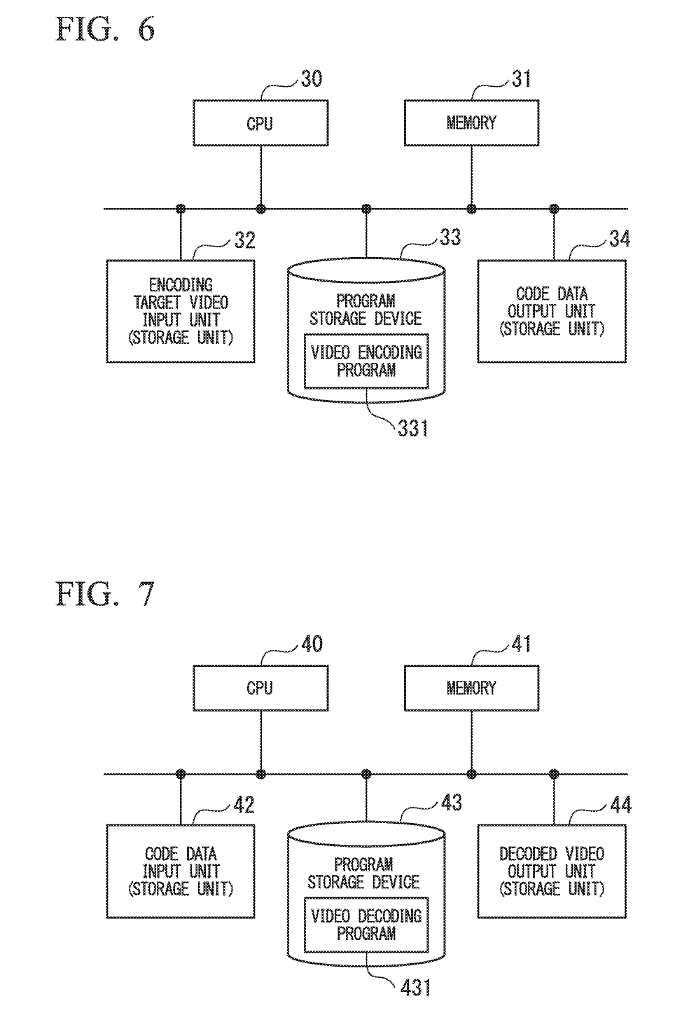

FIG. 6 shows an example of a hardware configuration of the above-described video encoding apparatus 100 formed using a computer and a software program.

In the relevant system, the following elements are connected via a bus:

(i) a CPU 30 that executes the relevant program;
(ii) a memory 31 (e.g., RAM) that stores the program and data accessed by the CPU 30;
(iii) an encoding target video input unit 32 that makes a video signal of an encoding target from a camera or the like input into the video encoding apparatus and may be a storage unit (e.g., disk device) which stores the video signal;
(iv) a program storage device 33 that stores a video encoding program 331 which is a software program for making the CPU 30 execute the operation explained with reference to the drawings such as FIG. 2; and
(v) a code data output unit 34 that outputs coded data via a network or the like, where the coded data is generated by executing the video encoding program that is loaded on the memory 31 and executed by the CPU 30, and the output unit may be a storage unit (e.g., disk device) which stores the coded data.

Other hardware elements (not shown) are also provided so as to implement the relevant method, which are a code data storage unit, a reference frame storage unit, and the like. In addition, a video signal code data storage unit or a prediction information code data storage unit may be used.

FIG. 7 shows an example of a hardware configuration of the above-described video decoding apparatus 200 formed using a computer and a software program.

In the relevant system, the following elements are connected via a bus:

(i) a CPU 40 that executes the relevant program;
(ii) a memory 41 (e.g., RAM) that stores the program and data accessed by the CPU 40;
(iii) a code data input unit 42 that makes code data obtained by a video encoding apparatus (which performs a method according to the present invention) input into the video decoding apparatus, where the input unit may be a storage unit (e.g., disk device) which stores the code data;
(iv) a program storage device 43 that stores a video decoding program 431 which is a software program for making the CPU 40 execute the operation explained with reference to the drawings such as FIG. 4; and
(v) a decoded video data output unit 44 that outputs decoded video to a reproduction device or the like, where the decoded video is obtained by executing the video decoding program that is loaded on the memory 41 and executed by the CPU 40.

Other hardware elements (not shown) are also provided so as to implement the relevant method, which include a reference frame storage unit. In addition, a video signal code data storage unit or a prediction information code data storage unit may be used.

As explained above, when a picture, to which both the inter-frame prediction and the inter-view prediction are applicable in the multi-view video encoding, is subjected to the inter-frame prediction and the inter-view prediction, the corrective prediction is performed based on the information that indicates references utilized in these predictions, so as to correct the prediction errors of the predictions. Accordingly, it is possible to reduce the prediction residual and thus reduce the amount of code required for the encoding of the prediction residual.

The video encoding apparatus shown in FIG. 1 and the video decoding apparatus 200 shown in FIG. 3 in the above-described embodiments may be implemented by utilizing a computer.

For the above implementation, a program for executing target functions may be stored in a computer readable storage medium, and the program stored in the storage medium may be loaded and executed on a computer system.

Here, the computer system has hardware resources which may include an OS and peripheral devices.

The above computer readable storage medium is a storage device, for example, a portable medium such as a flexible disk, a magneto optical disk, a ROM, or a CD-ROM, or a memory device such as a hard disk built in a computer system.

The computer readable storage medium also includes a device for temporarily storing the program, such as a communication line utilized to transmit the program via a network (e.g., the Internet) or a communication line (e.g., a telephone line), or a volatile memory in a computer system which functions as a server or client for such transmission.

In addition, the program may execute part of the above-explained functions. The program may also be a program by which the above-described functions can be executed by a combination of this program and an existing program which has already been stored in the relevant computer system. The program may also be implemented by utilizing a hardware resource such as a PLD (Programmable Logic Device) or an FPGA (Field Programmable Gate Array).

While the embodiments of the present invention have been described and shown above, it should be understood that these are exemplary embodiments of the invention and are not to be considered as limiting. Additions, omissions, substitutions, and other modifications can be made without departing from the technical concept and scope of the present invention.

### INDUSTRIAL APPLICABILITY

The present invention can be applied to a case in which prediction in both directions pertaining to time and disparity is inappropriate and thus unidirectional prediction is employed, which causes an increase in the amount of code generated for the prediction residual. According to the application, prediction residuals for the predictions in both directions are corrected and the relevant amount of code is preferably reduced.

### REFERENCE SYMBOLS

101 encoding target video input unit
102 input image memory
103 reference picture memory
104 prediction unit
105 primary predicted image generation unit
106 corrective predicted image generation unit
107 predicted image generation unit
108 subtraction unit
109 transformation and quantization unit
110 inverse quantization and inverse transformation unit
111 addition unit
112 entropy encoding unit
201 code data input unit
202 code data memory
203 reference picture memory
204 entropy decoding unit
205 inverse quantization and inverse transformation unit
206 primary predicted image generation unit
207 corrective predicted image generation unit
208 predicted image generation unit
209 addition unit

1. A video encoding apparatus that performs inter-frame prediction in directions pertaining to time and disparity and predictive-encodes an encoding target video by generating a predicted image whose error is corrected, the apparatus comprising:
a prediction device that:
predicts an encoding target image by utilizing reference pictures which are previously-decoded pictures in the directions pertaining to time and disparity; and
determines inter-frame reference information and inter-viewpoint reference information which indicate individual reference parts on the reference pictures;
a primary predicted image generation device that generates a disparity predicted image based on the inter-viewpoint reference information and a motion predicted image based on the inter-frame reference information;
a corrective predicted image generation device that generates a corrective predicted image based on the inter-viewpoint reference information and the inter-frame reference information; and
a predicted image generation device that generates the predicted image from the disparity predicted image, the motion predicted image, and the corrective predicted image.

2. The video encoding apparatus in accordance with claim 1, wherein:
the predicted image generation device generates the predicted image by adding the disparity predicted image to the motion predicted image and subtracting the corrective predicted image from the sum of the addition.

3. The video encoding apparatus in accordance with claim 1, wherein:
the inter-viewpoint reference information and the inter-frame reference information each include information utilized to identify the corresponding reference picture; and
the corrective predicted image generation device generates the corrective predicted image with reference to a reference picture, as a corrective reference picture, which is a picture from the same viewpoint as that of the reference picture indicated by the inter-viewpoint reference information and belongs to a frame to which the reference picture indicated by the inter-frame reference information belongs.

4. The video encoding apparatus in accordance with claim 3, wherein:
the inter-viewpoint reference information and the inter-frame reference information each further include information utilized to identify a reference position on the corresponding reference picture; and
the corrective predicted image generation device generates the corrective predicted image by determining a reference position on the corrective reference picture based on the inter-viewpoint reference information and the inter-frame reference information.

5. The video encoding apparatus in accordance with claim 1, further comprising:
a prediction information encoding device that encodes information utilized to identify the inter-viewpoint reference information and the inter-frame reference information.

6. The video encoding apparatus in accordance with claim 1, wherein:
the prediction device generates any one of the inter-frame reference information and the inter-viewpoint reference information based on prediction information utilized when the reference part indicated by the other reference information was encoded.

7. A video decoding apparatus that decodes code data which has been predictive-encoded by performing inter-frame prediction in directions pertaining to time and disparity and generating a predicted image whose error is corrected, the apparatus comprising:
a prediction device that:
predicts a decoding target image by utilizing reference pictures which are previously-decoded pictures in the directions pertaining to time and disparity; and
determines inter-frame reference information and inter-viewpoint reference information which indicate individual reference parts on the reference pictures;
a primary predicted image generation device that generates a disparity predicted image based on the inter-viewpoint reference information and a motion predicted image based on the inter-frame reference information;
a corrective predicted image generation device that generates a corrective predicted image based on the inter-viewpoint reference information and the inter-frame reference information; and
a predicted image generation device that generates the predicted image from the disparity predicted image, the motion predicted image, and the corrective predicted image.

8. The video decoding apparatus in accordance with claim 7, wherein:
the predicted image generation device generates the predicted image by adding the disparity predicted image to the motion predicted image and subtracting the corrective predicted image from the sum of the addition.

9. The video decoding apparatus in accordance with claim 7, wherein:
the inter-viewpoint reference information and the inter-frame reference information each include information utilized to identify the corresponding reference picture; and
the corrective predicted image generation device generates the corrective predicted image with reference to a reference picture, as a corrective reference picture, which is a picture from the same viewpoint as that of the reference picture indicated by the inter-viewpoint reference information and belongs to a frame to which the reference picture indicated by the inter-frame reference information belongs.

10. The video decoding apparatus in accordance with claim 9, wherein:
the inter-viewpoint reference information and the inter-frame reference information each further include information utilized to identify a reference position on the corresponding reference picture; and
the corrective predicted image generation device generates the corrective predicted image by determining a reference position on the corrective reference picture based on the inter-viewpoint reference information and the inter-frame reference information.

11. The video decoding apparatus in accordance with claim 7, further comprising:
a prediction information decoding device that decodes prediction information from the code data so as to generate prediction information utilized to identify the inter-viewpoint reference information and the inter-frame reference information,
wherein the prediction device determines the inter-frame reference information and the inter-viewpoint reference information based on the generated prediction information.

12. The video decoding apparatus in accordance with claim 7, wherein:
the prediction device decodes any one of the inter-frame reference information and the inter-viewpoint reference information from the code data and generates the other reference information based on prediction information utilized when the reference part indicated by the decoded reference information was decoded.

13. A video encoding method performed by a video encoding apparatus that performs inter-frame prediction in directions pertaining to time and disparity and predictive-encodes an encoding target video by generating a predicted image whose error is corrected, the method comprising:
a prediction step that:
predicts an encoding target image by utilizing reference pictures which are previously-decoded pictures in the directions pertaining to time and disparity; and
determines inter-frame reference information and inter-viewpoint reference information which indicate individual reference parts on the reference pictures;
a primary predicted image generation step that generates a disparity predicted image based on the inter-viewpoint reference information and a motion predicted image based on the inter-frame reference information;
a corrective predicted image generation step that generates a corrective predicted image based on the inter-viewpoint reference information and the inter-frame reference information; and
a predicted image generation step that generates the predicted image from the disparity predicted image, the motion predicted image, and the corrective predicted image.

14. A video decoding method performed by a video decoding apparatus that decodes code data which has been predictive-encoded by performing inter-frame prediction in directions pertaining to time and disparity and generating a predicted image whose error is corrected, the method comprising:
a prediction step that:
predicts a decoding target image by utilizing reference pictures which are previously-decoded pictures in the directions pertaining to time and disparity; and
determines inter-frame reference information and inter-viewpoint reference information which indicate individual reference parts on the reference pictures;
a primary predicted image generation step that generates a disparity predicted image based on the inter-viewpoint reference information and a motion predicted image based on the inter-frame reference information;
a corrective predicted image generation step that generates a corrective predicted image based on the inter-viewpoint reference information and the inter-frame reference information; and
a predicted image generation step that generates the predicted image from the disparity predicted image, the motion predicted image, and the corrective predicted image.

15. A video encoding program utilized to make a computer execute the video encoding method in accordance with claim 13.

16. A video decoding program utilized to make a computer execute the video decoding method in accordance with claim 14.
